(19) United States
(12) Patent Application Publication
(10) Pub. No.: US 2016/0249373 A1
(43) Pub. Date: Aug. 25, 2016

(54) RADIO FREQUENCY COEXISTENCE IN A MULTIMODAL DEVICE THROUGH CHANNEL BLACKLISTING

(71) Applicant: QUALCOMM Incorporated, San Diego, CA (US)

(72) Inventors: Samel CELEBI, Summit, NJ (US); Akshay KUMAR, Blacksburg, VA (US)

(21) Appl. No.: 14/626,459

(22) Filed: Feb. 19, 2015

(51) Int. Cl. H04W 72/12; H04W 52/02

(52) U.S. Cl. CPC H04W 72/1215; H04W 52/0206; H04W 88/10

(57) ABSTRACT

Systems and methods are disclosed for improving radio frequency coexistence in a multimodal device. The multimodal device may select a subset comprising at least one transmitter frequency channel (TFC) from among a set of TFCs associated with the multimodal device, transmit a transmission signal on each TFC of the selected subset, generate a power level measurement based on a signal received during transmitting of the transmission signal at a receiving frequency channel (RFC) associated with the multimodal device, and identify a self-interfering TFC from among the set of TFCs based on the selected subset and the generated power level measurement.

### INTRODUCTION

Aspects of this disclosure relate generally to telecommunications, and more particularly to multimode wireless devices and the like.

Wireless communication systems are widely deployed to provide various types of communication content, such as voice, data, multimedia, and so on.

As new protocols for wireless devices are developed, it becomes increasingly likely that a single wireless device will include multiple radios (also referred to as transceivers), each of which is specifically configured to interact within one or more specific wireless communications systems. A single device that includes multiple radios may be referred to as a “multimode” or “multimodal” device. Although the different wireless protocols typically operate within separate bands of the radio frequency (RF) spectrum, when radios are co-located in a single multimodal device, transmissions on one or more frequencies may interfere with receptions on another frequency. This “self-interference” may occur despite the fact that the co-located radios are operating in accordance with different wireless protocols, or in different bands of the RF spectrum.

This self-interference may occur in any wireless device that contains multiple radios, for example, access terminals (ATs), user equipments (UEs), access points (APs), base stations, etc. For example, cellular networks increasingly employ “small cell” APs in order to supplement conventional “macro cell” networks by improving specific geographic coverage, such as for residential homes, office buildings, etc. Small cell APs provide incremental capacity growth, but in order to do so effectively, they are often required to support multiple wireless protocols, each requiring a separate radio. For example, a small cell AP may comprise separate radios for LTE, UMTS, Wi-Fi, and GPS.

### SUMMARY

In one aspect, the present disclosure provides a method of improving radio frequency coexistence in a multimodal device. The method may comprise, for example: selecting a subset comprising at least one transmitter frequency channel (TFC) from among a set of TFCs associated with the multimodal device, transmitting a transmission signal on each TFC of the selected subset, generating a power level measurement based on a signal received during transmitting of the transmission signal at a receiving frequency channel (RFC) associated with the multimodal device, and identifying a self-interfering TFC from among the set of TFCs based on the selected subset and the generated power level measurement.

In another aspect, the present disclosure provides an apparatus for improving radio frequency coexistence in a multimodal device. The apparatus may comprise, for example: means for selecting a subset comprising at least one transmitter frequency channel (TFC) from among a set of TFCs associated with the multimodal device, means for transmitting a transmission signal on each TFC selected by the means for selecting a subset, means for generating a power level measurement based on a signal received during transmitting of the transmission signal at a receiving frequency channel (RFC) associated with the multimodal device, and means for identifying a self-interfering TFC from among the set of TFCs based on the subset selected by the means for selecting a subset and the power level measurement generated by the means for generating a power level measurement.

In another aspect, the present disclosure provides a computer-readable medium comprising code, which, when executed by a processor, causes the processor to perform operations for improving radio frequency coexistence in a multimodal device. The computer-readable medium may comprise, for example: code for selecting a subset comprising at least one transmitter frequency channel (TFC) from among a set of TFCs associated with the multimodal device, code for transmitting a transmission signal on each TFC of the selected subset, code for generating a power level measurement based on a signal received during transmitting of the transmission signal at a receiving frequency channel (RFC) associated with the multimodal device, and code for identifying a self-interfering TFC from among the set of TFCs based on the selected subset and the generated power level measurement.

In another aspect, the present disclosure provides a multimodal device. The multimodal device may comprise, for example: a channel blacklisting algorithm component configured to select a subset comprising at least one transmitter frequency channel (TFC) from among a set of TFCs associated with the multimodal device, at least one transceiver configured to transmit a transmission signal on each TFC of the selected subset, and a received power measurement component configured to generate a power level measurement based on a signal received at a receiving frequency channel (RFC) associated with the multimodal device, wherein the channel blacklisting algorithm component is further configured to identify a self-interfering TFC from among the set of TFCs based on the selected subset and the power level measurement generated by the received power measurement component.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example mixed-deployment wireless communication system including macro cell base stations and small cell base stations.

FIG. 2 illustrates an example small cell base station with co-located radio components (e.g., LTE and Wi-Fi).

FIG. 3 illustrates an example of a multimodal device in accordance with an aspect of the disclosure.

FIG. 4 illustrates an example of a method of improving RF coexistence in a multimodal device in accordance with an aspect of the disclosure.

FIG. 5 illustrates an example of a method of operating a multimodal device having improved RF coexistence in accordance with an aspect of the disclosure.

FIG. 6 illustrates an example of a method of improving RF coexistence in a multimodal device in accordance with an aspect of the disclosure in accordance with another aspect of the disclosure.

FIG. 7(a) illustrates the respective statuses of an exemplary set of TFCs at a distinct point in time during the operation of the method of FIG. 6.

FIG. 7(b) illustrates the respective statuses of the same exemplary set of TFCs at a later point in time during the operation of the method of FIG. 6.

FIG. 7(c) illustrates the respective statuses of the same exemplary set of TFCs at a still later point in time during the operation of the method of FIG. 6.

FIG. 7(d) illustrates the respective statuses of the same exemplary set of TFCs at a still later point in time during the operation of the method of FIG. 6.

FIG. 7(e) illustrates the respective statuses of the same exemplary set of TFCs at a still later point in time during the operation of the method of FIG. 6.

FIG. 7(f) illustrates the respective statuses of the same exemplary set of TFCs at a still later point in time during the operation of the method of FIG. 6.

FIG. 7(g) illustrates the respective statuses of the same exemplary set of TFCs at a still later point in time during the operation of the method of FIG. 6.

FIG. 7(h) illustrates the respective statuses of the same exemplary set of TFCs at a still later point in time during the operation of the method of FIG. 6.

FIG. 8 illustrates an example of a method for operating a multimodal device in accordance with an aspect of the disclosure.

FIG. 9 illustrates an example of a modification of the method of improving RF coexistence depicted in FIG. 6.

FIG. 10 is a simplified block diagram of several sample aspects of components that may be employed in communication nodes and configured to support communication as taught herein.

FIG. 11 is a simplified block diagrams of several sample aspects of apparatuses configured to support communication as taught herein.

FIG. 12 is another simplified block diagrams of several sample aspects of apparatuses configured to support communication as taught herein.

### DETAILED DESCRIPTION

As new protocols for wireless devices are developed, it becomes increasingly likely that a single wireless device will include multiple radios (also referred to as transceivers), each of which is specifically configured to interact within one or more specific wireless communications systems. A multimodal device typically operates within several distinct bands of the radio frequency (RF) spectrum, but may still be susceptible to self-interference. This self-interference may occur in any wireless device that contains multiple radios, for example, access terminals (ATs), user equipments (UEs), access points (APs), base stations, etc.

Even when each radio in a given wireless device is allocated its own RF resources (power amplifier, mixer, filter, antenna, etc.), it becomes increasingly difficult to provide sufficient isolation amongst the radios due to the small (and increasingly smaller) form factors of the components. The RF coupling between transmitters and receivers within the wireless devices can create self-interference. The interference from a single out-of-band transmitter signal may be benign. However, when leakages from multiple radios are exposed to receiver nonlinearities, the superposition of these out-of-band signals can modulate each other in various combinations such that the resulting interference signal lands in the receiver's band of interest.

The present disclosure relates generally to methods for improving RF coexistence in multimode wireless devices. In particular, a subset of transmission frequency channels (TFCs) is selected from a set of TFCs associated with a given multimode wireless device. Then, the multimode wireless device transmits on the selected subset. While the multimode wireless device transmits on the selected subset of TFCs, it simultaneously measures the power levels of the signals received on the receiving frequency channels (RFCs) of the multimodal device. The measured power levels reflect the self-interference of the multimode wireless device. By selectively modifying the selected subset of TFCs in accordance with, for example, an algorithm, and measuring received self-interference signals, the multimode wireless device can identify one or more TFCs that are causing the most self-interference. The multimode wireless device can also store the identity of each identified TFC in a blacklist. Finally, the multimode wireless can stop or limit transmission on the blacklisted TFCs in order to reduce the self-interference of the device. Although a reduction in the number of TFCs tends to limit the functionality of the multimode wireless device, a reduction in the amount of self-interference experienced by the device will tend to improve the multimode wireless device's performance. Through selective blacklisting of TFCs, the operations of the multimode wireless device can be optimized such that the best possible tradeoff is obtained.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

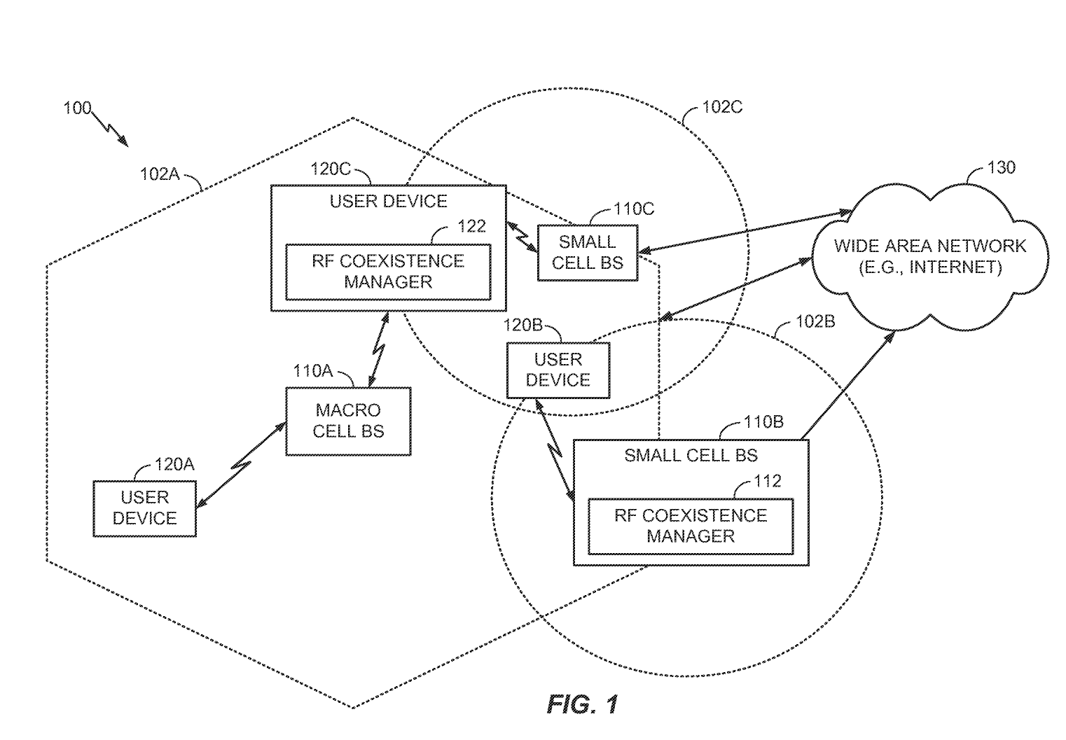

FIG. 1 illustrates an example mixed-deployment wireless communication system, in which small cell base stations are deployed in conjunction with and to supplement the coverage of macro cell base stations. As used herein, small cells generally refer to a class of low-powered base stations that may include or be otherwise referred to as femto cells, pico cells, micro cells, etc. As noted in the background above, they may be deployed to provide improved signaling, incremental capacity growth, richer user experience, and so on.

The illustrated wireless communication is a multiple-access system that is divided into a plurality of cells 102 and configured to support communication for a number of users. Communication coverage in each of the cells 102 is provided by a corresponding base station 110, which interacts with one or more user devices 120 via DownLink (DL) and/or UpLink (UL) connections. In general, the DL corresponds to communication from a base station to a user device, while the UL corresponds to communication from a user device to a base station.

As will be described in more detail below, these different entities may be variously configured in accordance with the teachings herein to provide or otherwise support the blacklisting operations discussed briefly above. For example, one or more of the small cell base stations 110 may include an RF coexistence management module 112, while one or more of the user devices 120 may include an RF coexistence management module 122.

As used herein, the terms “user device” and “base station” are not intended to be specific or otherwise limited to any particular Radio Access Technology (RAT), unless otherwise noted. In general, such user devices may be any wireless communication device (e.g., a mobile phone, router, personal computer, server, etc.) used by a user to communicate over a communications network, and may be alternatively referred to in different RAT environments as an Access Terminal (AT), a Mobile Station (MS), a Subscriber Station (STA), a User Equipment (UE), etc. Similarly, a base station may operate according to one of several RATs in communication with user devices depending on the network in which it is deployed, and may be alternatively referred to as an Access Point (AP), a Network Node, a NodeB, an evolved NodeB (eNB), etc. In addition, in some systems a base station may provide purely edge node signaling functions while in other systems it may provide additional control and/or network management functions.

Returning to FIG. 1, the different base stations 110 include an example macro cell base station 110A and two example small cell base stations 110B, 110C. The macro cell base station 110A is configured to provide communication coverage within a macro cell coverage area 102A, which may cover a few blocks within a neighborhood or several square miles in a rural environment. Meanwhile, the small cell base stations 110B, 110C are configured to provide communication coverage within respective small cell coverage areas 102B, 102C, with varying degrees of overlap existing among the different coverage areas. In some systems, each cell may be further divided into one or more sectors (not shown).

Turning to the illustrated connections in more detail, the user device 120A may transmit and receive messages via a wireless link with the macro cell base station 110A, the message including information related to various types of communication (e.g., voice, data, multimedia services, associated control signaling, etc.). The user device 120B may similarly communicate with the small cell base station 110B via another wireless link, and the user device 120C may similarly communicate with the small cell base station 110C via another wireless link. In addition, in some scenarios, the user device 120C, for example, may also communicate with the macro cell base station 110A via a separate wireless link in addition to the wireless link it maintains with the small cell base station 110C.

As is further illustrated in FIG. 1, the macro cell base station 110A may communicate with a corresponding wide area or external network 130, via a wired link or via a wireless link, while the small cell base stations 110B, 110C may also similarly communicate with the network 130, via their own wired or wireless links. For example, the small cell base stations 110B, 110C may communicate with the network 130 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The network 130 may comprise any type of electronically connected group of computers and/or devices, including, for example, Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 130 includes network variations such as the public Internet, a private network within the Internet, a secure network within the Internet, a private network, a public network, a value-added network, an intranet, and the like. In certain systems, the network 130 may also comprise a Virtual Private Network (VPN).

Accordingly, it will be appreciated that the macro cell base station 110A and/or either or both of the small cell base stations 110B, 110C may be connected to the network 130 using any of a multitude of devices or methods. These connections may be referred to as the “backbone” or the “backhaul” of the network, and may in some implementations be used to manage and coordinate communications between the macro cell base station 110A, the small cell base station 110B, and/or the small cell base station 110C. In this way, as a user device moves through such a mixed communication network environment that provides both macro cell and small cell coverage, the user device may be served in certain locations by macro cell base stations, at other locations by small cell base stations, and, in some scenarios, by both macro cell and small cell base stations.

For their wireless air interfaces, each base station 110 may operate according to one of several RATs depending on the network in which it is deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2). These documents are publicly available.

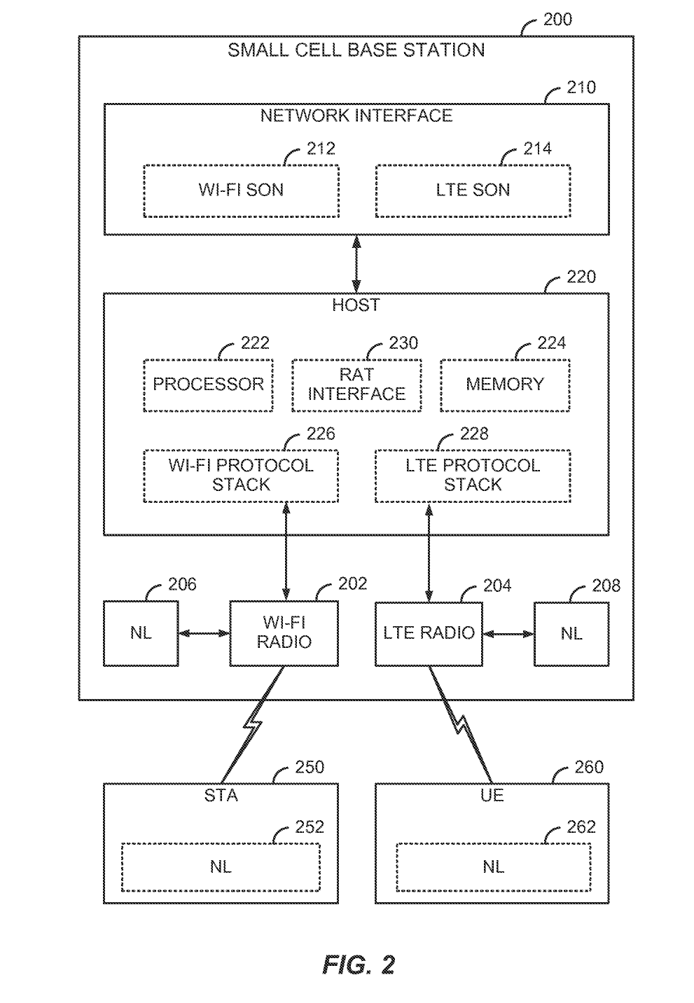

FIG. 2 illustrates an example small cell base station with co-located radio components. The small cell base station 200 may correspond, for example, to one of the small cell base stations 110B, 110C illustrated in FIG. 1. In this example, the small cell base station 200 is configured to provide a Wireless Local Area Network (WLAN) air interface (e.g., in accordance with an IEEE 802.11x protocol) in addition to a cellular air interface (e.g., in accordance with an LTE protocol). For illustration purposes, the small cell base station 200 is shown as including an 802.11x radio component/module (e.g., transceiver) 202 co-located with an LTE radio component/module (e.g., transceiver) 204.

As used herein, the term co-located (e.g., radios, base stations, transceivers, etc.) may include in accordance with various aspects, one or more of, for example: components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

Returning to FIG. 2, the Wi-Fi radio 202 and the LTE radio 204 may perform monitoring of one or more channels (e.g., on a corresponding carrier frequency) to perform various corresponding operating channel or environment measurements (e.g., CQI, RSSI, RSRP, or other RLM measurements) using corresponding Network/Neighbor Listen (NL) modules 206 and 208, respectively, or any other suitable component(s).

The small cell base station 200 may communicate, via the Wi-Fi radio 202 and the LTE radio 204, with one or more user devices, illustrated as an STA 250 and a UE 260, respectively. Similar to the Wi-Fi radio 202 and the LTE radio 204, the STA 250 includes a corresponding NL module 252 and the UE 260 includes a corresponding NL module 262 for performing various operating channel or environment measurements, either independently or under the direction of the Wi-Fi radio 202 and the LTE radio 204, respectively. In this regard, the measurements may be retained at the STA 250 and/or the UE 260, or reported to the Wi-Fi radio 202 and the LTE radio 204, respectively, with or without any pre-processing being performed by the STA 250 or the UE 260.

While FIG. 2 shows a single STA 250 and a single UE 260 for illustration purposes, it will be appreciated that the small cell base station 200 can communicate with multiple STAs and/or UEs. Additionally, while FIG. 2 illustrates one type of user device communicating with the small cell base station 200 via the Wi-Fi radio 202 (i.e., the STA 250) and another type of user device communicating with the small cell base station 200 via the LTE radio 204 (i.e., the UE 260), it will be appreciated that a single user device (e.g., a smartphone) may be capable of communicating with the small cell base station 200 via both the Wi-Fi radio 202 and the LTE radio 204, either simultaneously or at different times.

As is further illustrated in FIG. 2, the small cell base station 200 may also include a network interface 210, which may include various components for interfacing with corresponding network entities (e.g., Self-Organizing Network (SON) nodes), such as a component for interfacing with a Wi-Fi SON 212 and/or a component for interfacing with an LTE SON 214. The small cell base station 200 may also include a host 220, which may include one or more general purpose controllers or processors 222 and memory 224 configured to store related data and/or instructions. The host 220 may perform processing in accordance with the appropriate RAT(s) used for communication (e.g., via a Wi-Fi protocol stack 226 and/or an LTE protocol stack 228), as well as other functions for the small cell base station 200. In particular, the host 220 may further include a RAT interface 230 (e.g., a bus or the like) that enables the radios 202 and 204 to communicate with one another via various message exchanges.

In one possible scenario, the RF coexistence management module 112 may be included in one or more of the structures depicted in FIG. 2, for example, in the host 220. Alternatively, the processor 222 and memory 224 may perform the operations of the RF coexistence management module 112.

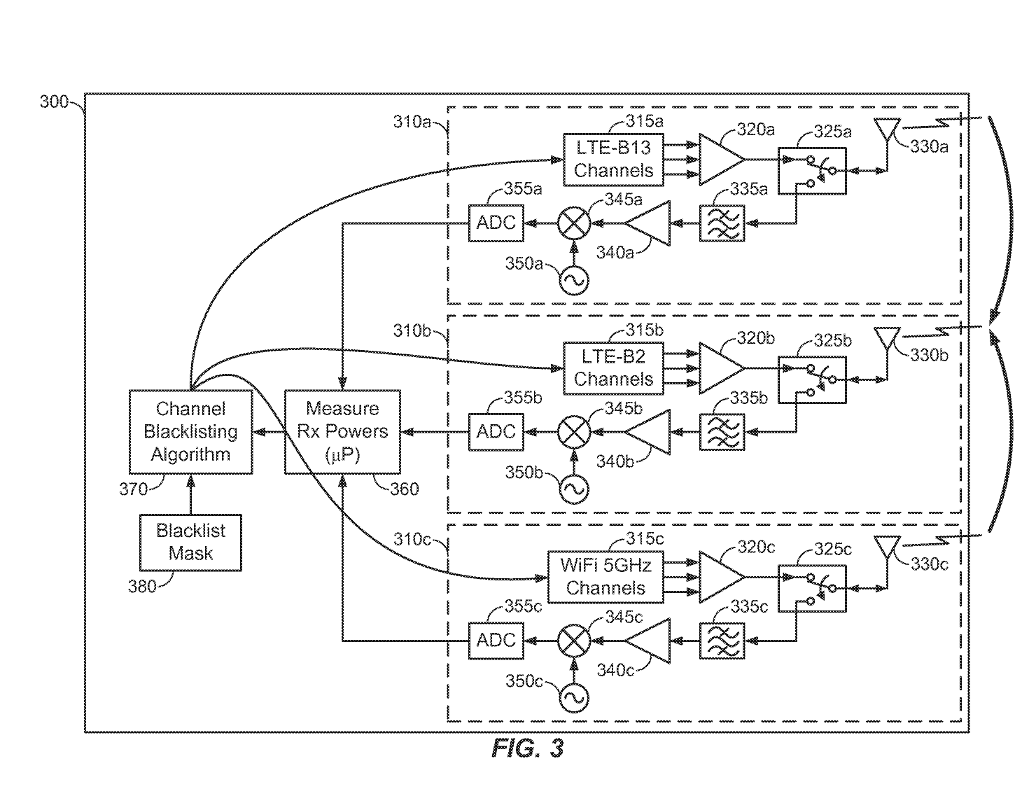

FIG. 3 generally illustrates a multimodal device 300 with multiple transceivers. In one possible example, the multimodal device 300 comprises the small cell base station 200 of FIG. 2. However, the multimodal device 300, and any of the components thereof, may be incorporated into any of the wireless communications device provided in the present disclosure, for example, the macro cell BS 110A, the user device 120C, etc. In general, each transceiver is configured to transmit on one or more TFCs and/or receive on one or more RFCs.

The multimodal device 300 includes a first transceiver 310a, a second transceiver 310b, and a third transceiver 310c. However, it will be understood that the multimodal device 300 is not limited to three transceivers, and that no transceiver is limited to a particular radio access technology. Moreover, the first transceiver 310a, a second transceiver 310b, and a third transceiver 310c may be analogous to one or more of the Wi-Fi radio 202 or LTE radio 204 depicted in FIG. 2.

The first transceiver 310a includes a transmission channel selection component 315a. One or more TFCs available to the first transceiver 310a may be selected by the transmission channel selection component 315a and transmitted through the power amplifier 320a and duplexer 325a to the antenna 330a. The power amplifier 320a amplifies the one or more signals received from the transmission channel selection component 315a. When the first transceiver 310a transmits, the duplexer 325a will relay the signals from the power amplifier 320a to the antenna 330a. When the first transceiver 310a receives, the duplexer 325a will relay signals received at the antenna 330a to a band pass filter 335a, low-noise amplifier 340a, and mixer 345a. The mixer 345a uses an oscillator 350a to generate an output from the signals received from the low-noise amplifier 340a. The output of the mixer 345a is transmitted to an analog-to-digital converter (ADC) 355a, which converts the signal to a digital signal and transmits the digital signal out of the first transceiver 310a.

The second transceiver 310b and third transceiver 310c each include analogous components. The second transceiver 310b includes transmission channel selection component 315b, power amplifier 320b, duplexer 325b, and antenna 330b, whereas the third transceiver 310c includes transmission channel selection component 315c, power amplifier 320c, duplexer 325c, and antenna 330c. The second transceiver 310b further includes band pass filter 335b, low-noise amplifier 340b, mixer 345b, oscillator 350b, and ADC 355b, whereas the third transceiver 310c further includes band pass filter 335c, low-noise amplifier 340c, mixer 345c, oscillator 350c, and ADC 355c. Although the first transceiver 310a, second transceiver 310b, and third transceiver 310c are shown to include substantially similar components, it will be understood that the transceivers may differ from one another and may be individually modified to omit various components or to include additional components. A person of ordinary skill may add, subtract, or modify the components included in first transceiver 310a, second transceiver 310b, and third transceiver 310c, as depicted in FIG. 3, without departing from the scope of the present disclosure.

Even though first transceiver 310a, second transceiver 310b, and third transceiver 310c may use different wireless protocols and separate bands of the RF spectrum, self-interference may occur in the multimodal device 300 due to RF coupling between transceivers in a transmitting state and transceivers in a receiving state. In one possible example (shown in FIG. 3), the first transceiver 310a comprises an LTE transceiver operating in 3GPP band 13, the second transceiver 310b comprises an LTE transceiver operating in 3GPP band 2, and the third transceiver 310c comprises a WLAN device (for example, a Wi-Fi device) operating in the 5 GHz unlicensed bands U-NII-1, -2, -2e, and -3. As depicted in FIG. 3, transmissions on one or more TFCs of the first transceiver 310a and third transceiver 310c may cause self-interference with one or more TFCs of the second transceiver 310b. If transmission signals from first transceiver 310a and third transceiver 310c are exposed to nonlinearities in the second transceiver 310b, the transmitted signals in 3GPP band 13 and the U-NII bands can superpose and modulate each other in various combinations such that the resulting interference signal lands in, for example, 3GPP band 2. As a result, the second transceiver 310b may receive an interference signal caused by the transmissions of the first transceiver 310a and third transceiver 310c.

In one possible example, the third transceiver 310c operates at a frequency f₁=5.6 GHz (e.g., in the WLAN band) and the second transceiver 310b operates at a frequency f₂=1930 MHz (e.g., in LTE band 2). Generally, the interference from the interaction of the transmissions at f₁ and f₂ will typically occur at f_{INT}=c₁*f₁+c₂*f₂, where f_{INT} is the frequency experiencing the interference, c₁=[±1/2, ±1, ±2] and c₂=[±1/2, ±1, ±2]. Although many of the combinations of c₁ and c₂ generate self-interferences at frequencies f_{INT} that are outside the receive bands of the multimodal transceiver, the pair c₁=1 and c₂=−2 yields interference at f_{NT}=1*5.6 GHz−2*1930 MHz=1740 MHz. If the first transceiver 310a happen to operate at 1740 MHz (e.g., in LTE band 3), then the first transceiver 310a will be susceptible to interference from the second transceiver 310b and third transceiver 310c. Because the 5 GHz WLAN band is relatively wide (approximately 800 MHz), it is potentially advantageous to blacklist the 5.6 GHz channel such that the third transceiver 310c does not use this channel when transmitting. If the 5.6 GHz channel is blacklisted, then self-interference at 1740 MHz can be eliminated, and there are still many channels within the WLAN band that may be used for transmissions.

According to one aspect of the disclosure, a received power measurement component 360 measures a power level associated with a signal received by one or more of first transceiver 310a, second transceiver 310b, and third transceiver 310c. As depicted in FIG. 3, for example, the received power measurement component 360 may be coupled to respective analog-to-digital converters 355a, 355b, and 355c of the three transceivers. The received power measurement component 360 may store the received power level data. Additionally or alternatively, the received power measurement component 360 may transmit the received power level data to a channel blacklisting algorithm component 370.

The channel blacklisting algorithm component 370 may be configured to command one or more of first transceiver 310a, second transceiver 310b, and third transceiver 310c to transmit on one or more TFCs, or alternatively, to restrict transmission on one or more TFCs. The channel blacklisting algorithm component 370 may perform this task by, for example, transmitting a channel selection signal to each of transmission channel selection component 315a, transmission channel selection component 315b, and transmission channel selection component 315c, as depicted in FIG. 3.

The channel blacklisting algorithm component 370 may be used to mitigate or prevent self-interference in the multimodal device 300. Additionally or alternatively, the channel blacklisting algorithm component 370 may be used to identify one or more self-interfering TFCs. According to an aspect of the disclosure, the channel blacklisting algorithm component 370 begins by commanding one or more of the transceivers associated with the multimodal device 300 to transmit on one or more specific TFCs. If the resulting transmissions cause self-interference within the multimodal device 300, then the interference signals received by one or more of the transceivers will be measured by the received power measurement component 360. On the basis of these measurements, the channel blacklisting algorithm component 370 may conclude that transmission on one or more TFCs of one or more transceivers is causing self-interference within the multimodal device 300. The channel blacklisting algorithm component 370 may repeat the transmission, or command one or more of the transceivers associated with the multimodal device 300 to transmit on a different TFC or set of TFCs. In either case, the received power measurement component 360 will transmit additional received power measurements to channel blacklisting algorithm component 370, thereby enabling identification of the TFCs which, when transmitted upon, are most likely to cause self-interference, or likely to cause the most self-interference.

According to another aspect of the disclosure, the channel blacklisting algorithm component 370 may further conclude that restricting transmissions associated with the one or more TFCs will mitigate or prevent future self-interference in the multimodal device 300. According to another aspect of the disclosure, the channel blacklisting algorithm component 370 may further command one or more transceivers of the multimodal device 300 to blacklist the one or more TFCs, or alternatively, to restrict transmissions to one or more TFCs which are not known to cause self-interference.

The channel blacklisting algorithm component 370 may include a stand-alone, special-purpose processor and complementary storage medium. Alternatively, the operations of the channel blacklisting algorithm component 370 may be implemented using a processor and storage medium used to perform other operations of the multimodal device 300. The processor and storage medium may be analogous to, for example, the processor 222 and memory 224 depicted in FIG. 2. Additionally or alternatively, the channel blacklisting algorithm component 370 may be included in one or more of the RF coexistence management module 112 or the RF coexistence management module 122 depicted in FIG. 1.

FIG. 3 also shows a blacklist mask 380, an optional component which identifies TFCs that cannot be blacklisted by channel blacklisting algorithm component 370. According to one example, the TFCs associated with the multimodal device 300 may be represented as a TFC vector having i elements having an index from 1 to N. If the i^{th} TFC is enabled for transmission, then the i^{th} vector (to which the i^{th} TFC is indexed) may be represented with a 1. Alternatively, if the i^{th} vector is disabled from transmitting, then the i^{th} vector may be represented with a 0. The blacklist mask 380 may include a bit mask vector also having an index from 1 to N in which TFCs that cannot be disabled are represented with a 1 and the TFCs that can be disabled are represented with a 0. By combining the TFC vector and the blacklist mask vector, the channel blacklisting algorithm component 370 may be prevented from disabling the elements in the blacklist mask vector which are represented by a 1.

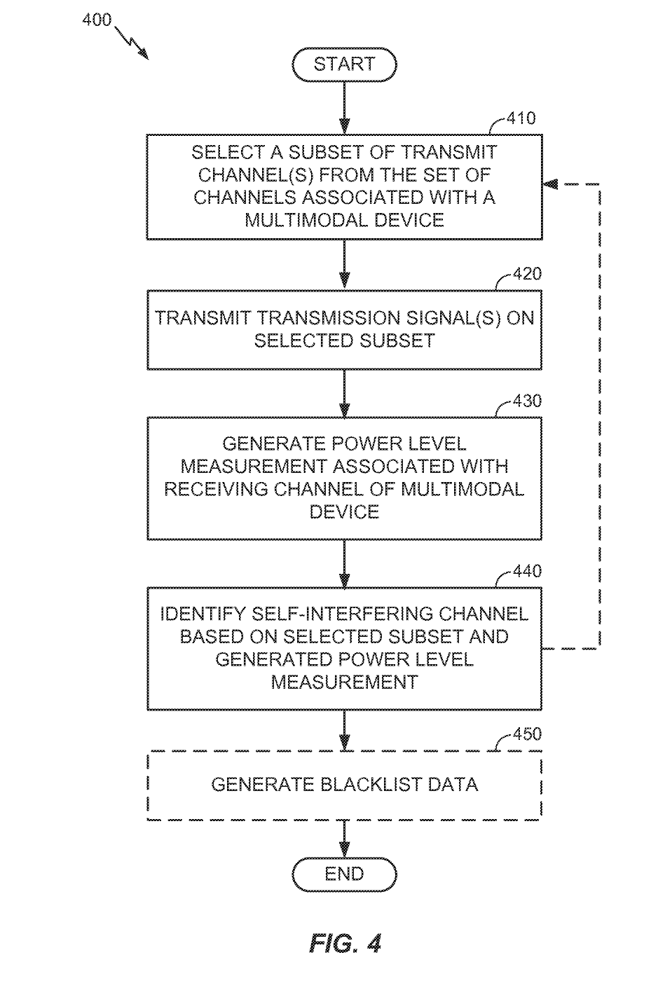

FIG. 4 generally illustrates a method 400 of improving RF coexistence in a multimodal device. The method 400 may be performed by, for example, the multimodal device 300 of FIG. 3.

At 410, the method 400 selects a subset of TFCs from a set of TFCs associated with the multimodal device 300. In one possible scenario, the subset includes every TFC associated with the multimodal device 300. In another possible scenario, the subset includes TFCs associated with one or more particular transceivers of the multimodal device 300, for example, TFCs in 3GPP band 13 and TFCs in unlicensed U-NII bands.

At 420, the method 400 transmits transmission signals on the selected subset of TFCs. The transmissions signals may be transmitted simultaneously from each TFC in the selected subset. The transmission signals may be broadcast at, for example, maximum power, and may consist of ‘dummy’ signals that contain random data or fixed data. Alternatively, the transmission signals may comprise additional data or information.

At 430, the method 400 generates a power level measurement associated with one or more RFCs associated with the multimodal device 300. The power level measurement may be generated by, for example, the received power measurement component 360 depicted in FIG. 3. The received power measurement data may be stored in the received power measurement component 360, or alternatively, in some other component of the multimodal device 300.

According to one aspect of the disclosure, the transmitting transceiver and the receiving transceiver are the same transceiver, for example, third transceiver 310c. In this aspect, the third transceiver 310c selects a subset 410 from among the one or more TFCs associated with the unlicensed U-NII bands, transmits on the selected subset at 420, and simultaneously generates power level measurements 430 on one or more RFCs in the unlicensed U-NII bands.

According to one aspect of the disclosure, RF coupling between different transceivers co-located in the multimodal device 300 can cause detectable power levels at 430. Even when the transceivers of the multimodal device 300 are isolated from all other transmission sources, transmissions from the multimodal device 300 itself can cause noise signals to appear on RFCs associated with the multimodal device 300. For example, harmonics, superposition, intermodulation, and other nonlinearities can result in noise signals. The noise signals may include unanticipated noise signals which may be difficult to mitigate using filtering techniques. Using multimodal device 300 as an example, system nonlinearities may coincide with the third harmonic of the RFCs of a 3GPP band 2 transceiver. The TFCs of the unlicensed band (˜5 GHz) plus twice the frequency of the TFCs of the 3GPP band 2 transceiver can produce intermodulation, thereby causing interference at RFCs of the 3GPP band 2.

At 440, the method 400 identifies at least one self-interfering TFC from among the set of TFCs associated with the transmitting transceiver based on the subset selected at 410 and the power level measurement generated at 430. As used herein, a “self-interfering” TFC is a TFC associated with a multimodal device 300 which, when used to transmit, causes a noise signal to appear at one or more RFCs associated with the multimodal device 300. The self-interfering TFC may cause the noise signal to appear by transmitting, or by transmitting simultaneously with one or more additional TFCs associated with the multimodal device 300.

The at least one self-interfering TFC identified at 440 may be identified by the channel blacklisting algorithm component 370 depicted in FIG. 3. According to an aspect of the disclosure, the channel blacklisting algorithm component 370 identifies a self-interfering TFC based on the subset selected at 410 and the power level measurements generated at 430.

As noted above, the channel blacklisting algorithm component 370 may, at 420, command one or more of first transceiver 310a, second transceiver 310b, and third transceiver 310c to transmit on one or more TFCs, or alternatively, to restrict transmission to one or more TFCs. Alternatively, the subset may be identified by some other component, and the channel blacklisting algorithm component 370 may simply have access to data relating to the subset of TFCs selected at 410. In either case, the subset of TFCs selected at 410 may be identified using, for example, subset identification data. The subset identification data may be stored in the channel blacklisting algorithm component 370, or alternatively, in some other component of the multimodal device 300.

As noted above, the received power measurement component 360 measures a power level associated with a signal received by one or more of first transceiver 310a, second transceiver 310b, and third transceiver 310c. The received power measurement component 360 may measure and store the received power level data at 430. Additionally or alternatively, the received power measurement component 360 may transmit the received power level data to a channel blacklisting algorithm component 370. In either case, received power level data is accessible to the channel blacklisting algorithm component 370.

In order to identify one or more self-interfering TFCs at 440, the channel blacklisting algorithm component 370 uses the subset identification data (relating to 410) and received power level data (relating to 430). According to one aspect of the disclosure, the multimodal device 300 performs multiple iterations of subset selection 410, transmission 420, and power level measurement generation 430. For example, the multimodal device 300 may select a first subset at 410 and transmit on the selected TFCs at 420. Then the multimodal device 300 may generate power level measurements at 430. Finally, the multimodal device 300 may use first subset identification data (derived from selecting the first subset at 410) and first received power level data (derived from generating power level measurements at 430) to identify a first self-interfering TFC at 440. The multimodal device 300 may then perform another iteration in which it uses second subset identification data (derived from selecting a second subset at 410) and second received power level data (derived from generating second power level measurements at 430) to identify a second self-interfering TFC at 440. The iterations may continue until, for example, there are no additional self-interfering TFCs to be identified.

In another possible example, the multimodal device 300 is unable to identify the first self-interfering TFC at 440. In this example, the multimodal device 300 may perform another iteration in which it uses second subset identification data (derived from selecting a second subset at 410) and second received power level data (derived from generating second power level measurements at 430). The multimodal device 300 may determine that a first self-interfering TFC can be identified at 440 based on the first subset identification data, second subset identification data, first received power level data, and second received power level data. In such a case, the multimodal device 300 will identify the first self-interfering TFC at 440. Alternatively, the multimodal device 300 may determine that yet more iterations are necessary. The iterations may continue until, for example, at least one self-interfering TFC has been identified, or alternatively, until the multimodal device 300 determines that there are no additional self-interfering TFCs to be identified.

At 450, the method 400 optionally generates blacklist data. The blacklist data may comprise, for example, a list of TFCs which will not be used to transmit by the multimodal device 300. Alternatively, the blacklist data may indicate that there are no self-interfering TFCs. Alternatively, the blacklist data may comprise a list of TFCs that preferably are not used to transmit by the multimodal device 300, and may further specify one or more conditions under which the TFCs will or will not be used to transmit by the multimodal device 300. The blacklist data may be generated or updated each time a self-interfering TFC is identified at 440. Alternatively, the blacklist data is generated or updated after all self-interfering TFCs have been identified, or after the multimodal device 300 determines that additional self-interfering TFCs are not likely to be identified.

The method 400 depicted in FIG. 4 may be performed at any time and may be performed again at any additional time. In one possible scenario, the method 400 is performed after the multimodal device 300 is fabricated, possibly as part of a quality control scheme. For example, the method 400 may be performed prior to run-time operation of the multimodal device 300, i.e. when the device is not attached to another wireless device. In this case, the method 400 can be thought of as a self-calibration procedure that identifies the TFCs that are most likely to create coexistence issues.

Additionally or alternatively, the method 400 may be performed intermittently or periodically. Additionally or alternatively, the method 400 may be performed in response to a determination that the multimodal device 300 is experiencing high levels of interference at one or more RFCs.

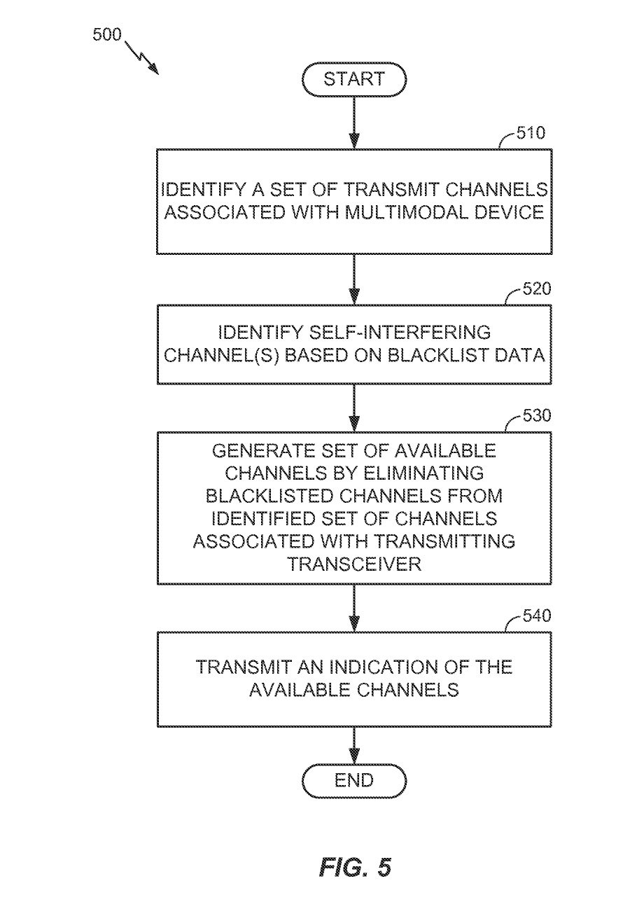

FIG. 5 generally illustrates a method 500 of operating a multimodal device. The method 500 may be performed by, for example, the multimodal device 300 of FIG. 3.

At 510, the method 500 identifies a set of TFCs associated with a multimodal device such as multimodal device 300.

At 520, the method 500 identifies one or more self-interfering TFCs based on blacklist data. The blacklist data may be obtained using, for example, the method 400 depicted in FIG. 4. The blacklist data may be maintained in storage until it is retrieved for usage at 520. The blacklist data may also remain in storage for later use. According to the example, the blacklist data may indicate that one or more TFCs associated with the multimodal device 300 are self-interfering TFCs.

At 530, the method 500 generates a set of available TFCs. The available TFCs comprise the TFCs on which the multimodal device 300 can transmit without causing interference, or alternatively, the TFCs on which the multimodal device 300 can transmit without causing an intolerable level of interference. The set of available channels is determined by eliminating blacklisted TFCs (i.e., the TFCs identified in the blacklist data at 520) from the set of TFCs associated with the multimodal device 300 (identified at 510).

If the blacklist data specifies one or more conditions under which a given TFC should or should not be available for transmission, then, at 530, the method 500 may determine whether the one or more conditions have been met prior to generating the set of available TFCs.

At 530, the method 500 may optionally check the available TFCs against the blacklist mask 380, as depicted in FIG. 3. According to this example, the blacklist mask 380 identifies one or more TFCs that are always included in the set of available TFCs, regardless of whether the one or more TFCs are blacklisted.

At 540, the method transmits an indication of the available TFCs. The indicator transmission transmitted at 540 may be analogous to, for example, an advertisement or announcement of one or more available TFCs. The indicator transmission may be transmitted on any suitable TFC and may be included with other data, for example, in a system information block. For example, the indication of the available TFCs may be broadcasted over a Radio Resource Channel in accordance with air interface standards.

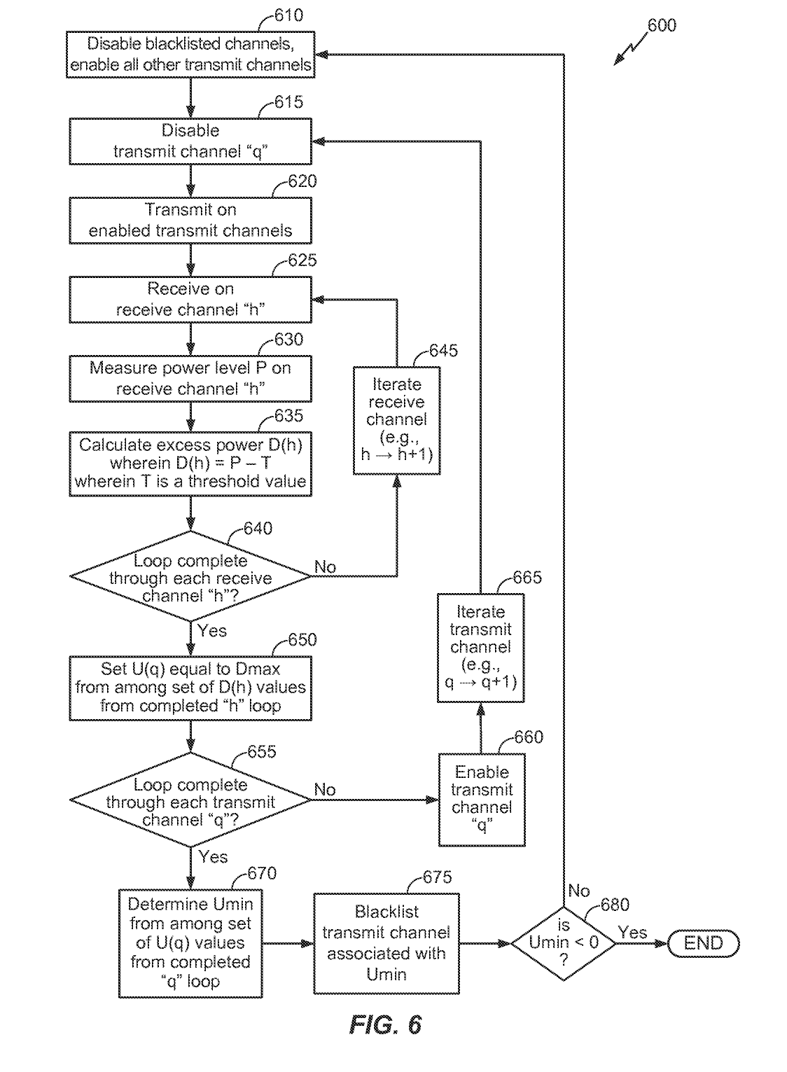

FIG. 6 generally illustrates a method 600 of improving RF coexistence in a multimodal device such as multimodal device 300. The method 600 is an example of a particular implementation of some aspects of the method 400 depicted in FIG. 4.

Each TFC associated with the multimodal device 300 can be categorized as part of either a first set {A} of TFCs or a second set {B} of TFCs. The first set {A} includes those TFCs that cannot be blacklisted. For example, if the multimodal device 300 includes the blacklist mask 380 depicted in FIG. 3, then the blacklist mask 380 may identify one or more TFCs that cannot be blacklisted. The TFCs identified by the blacklist mask 380 are included in the first set {A}. The remaining TFCs (the TFCs that can be blacklisted) are categorized in the second set {B}. On the other hand, if the multimodal device 300 does not include a blacklist mask 380 or the like, then the second set {B} may include every TFC associated with the multimodal device 300.

The multimodal device 300 may comprise a memory (not shown) in which a lookup table identifies each TFC associated with the device, and indexes each TFC using an index number. In a further example, the lookup table may also track various properties of each TFC, i.e., which of the TFCs are included on the blacklist mask 380, which of the TFCs are included in the first set {A}, which of the TFCs are included in the second set {B}, etc. In one possible scenario, the multimodal device 300 divides the set of TFCs associated with the multimodal device 300 into the first set {A} and the second set {B} and stores the results in the lookup table. Additional properties (to be described below) may also be included in the lookup table, for example, which of the TFCs are included in a third set {C}, which of the TFCs are blacklisted, an enabled/disabled status of each TFC, an excess power level “U” associated with each TFC, etc. The properties associated with each TFC may be modified as necessary in order to facilitate performance of method 600, as described below.

At 610, method 600 enables all of the TFCs associated with the multimodal device 300, except those that are blacklisted (as described below). Because the first set {A} include TFCs that cannot be blacklisted, it will be understood that each TFC in the first set {A} will be enabled at 610. It will be further understood that upon initiation of method 600, there may not be any TFCs which are blacklisted. In this case, every TFC in the second set {B} will also be enabled. However, as method 600 proceeds, one or more TFCs may be blacklisted as described below.

A third set {C} is defined as a subset of second set {B} that includes the elements of second set {B} that have not been blacklisted (as described below). It will be understood that upon initiation of method 600, there may be no blacklisted TFCs, and that the third set {C} will therefore be identical to the second set {B}. However, as method 600 is performed, one or more TFCs may be blacklisted as described below, and the number of elements in the third set {C} may therefore be reduced relative to the number of element in the second set {B}.

At 615, method 600 disables a single additional TFC, hereinafter referred to as TFC “q”. The TFC “q” that is to be disabled is selected from the third set {C}. In other words, the TFC “q” is selected from among the TFCs which can be blacklisted, but have not in fact been blacklisted at the time of disabling 615. It will be understood that more than one TFCs may be disabled at 615; however, for the purposes of the following explanation, FIG. 6 depicts a method 600 in which a single channel TFC “q” is selectively disabled at 615.

At 620, the multimodal device 300 transmits on each enabled TFC. The transmission 620 may be analogous to the transmission 420 depicted in FIG. 4. It will be understood that there will be no transmission on any blacklisted TFCs, because blacklisted TFCs were disabled at 610. It will be further understood that there will be no transmission on TFC “q”, because TFC “q”, which was disabled at 615, is serving as the disabled additional TFC.

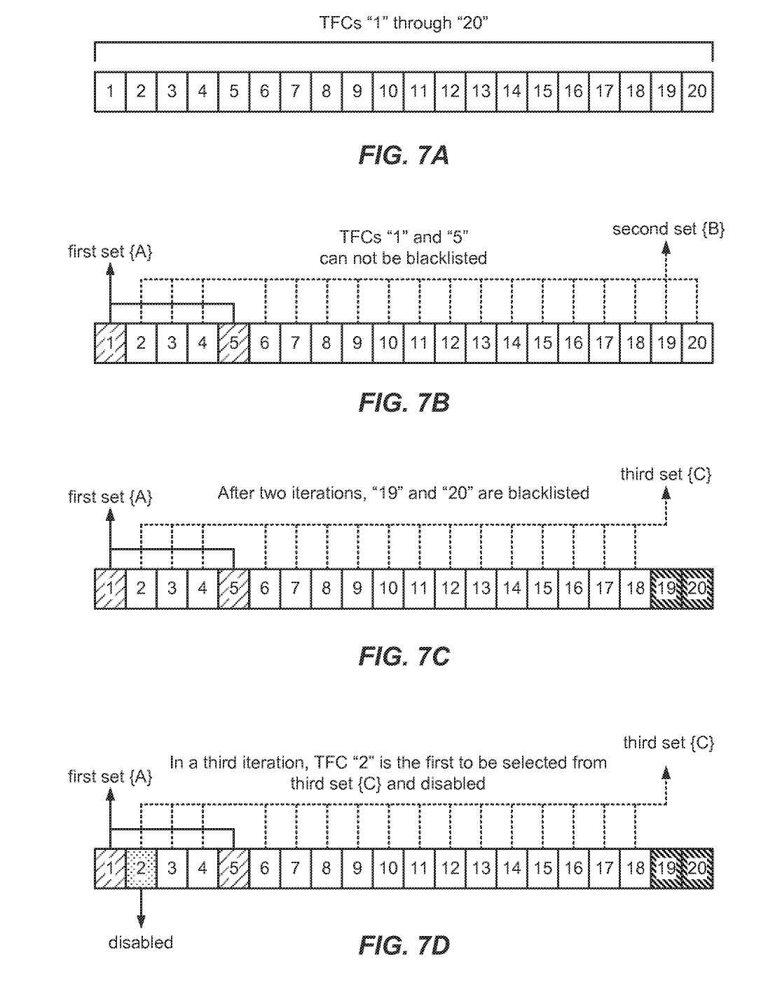

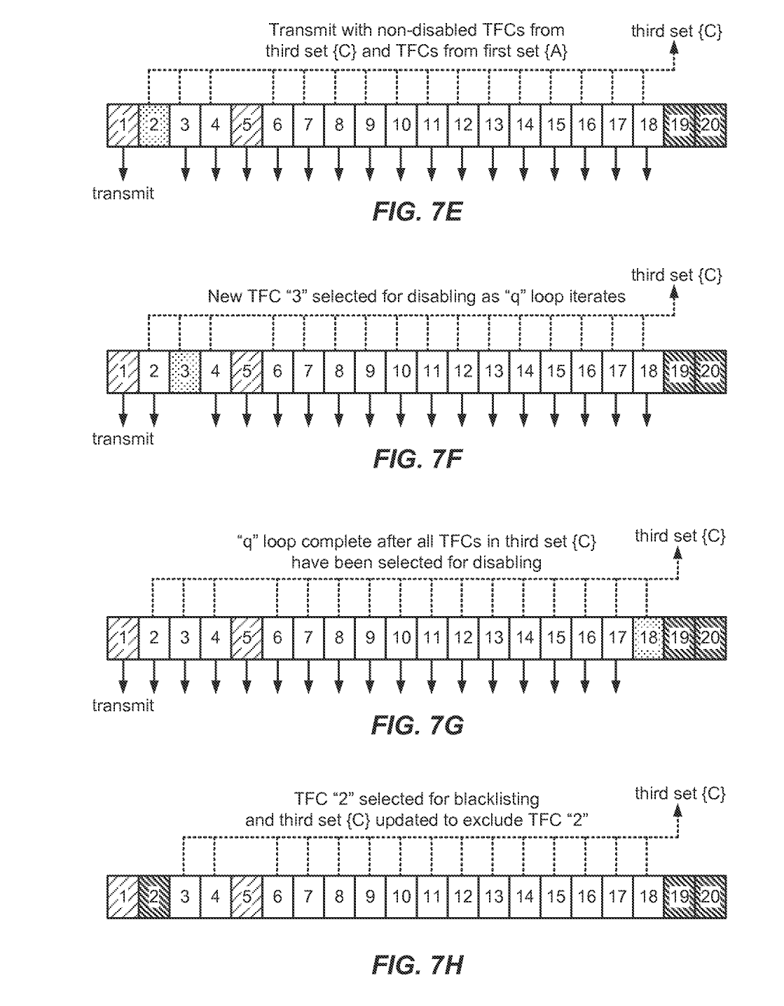

As an example, consider a multimodal device 300 having 20 TFCs, numbered “1” through “20”. This example is depicted in FIG. 7(a). Suppose that TFCs “1” and “5” cannot be blacklisted. The first set {A} would therefore be defined as A={1, 5}. The second set {B} would accordingly be defined as B={2, 3, 4, 6 . . . 20}. Upon initiation of method 600, the third set {C} would be identical to the second set {B}, such that C={2, 3, 4, 6 . . . 20}. This example is depicted in FIG. 7(b). However, at some later time, one or more TFCs may have been blacklisted. If, for example, TFC “19” and TFC “20” had been blacklisted during two previous iterations of method 600, then the third set {C} would have fewer elements than second set {B}, such that C={2, 3, 4, 6 . . . 18}. This example is depicted in FIG. 7(c).

Supposing that C={2, 3, 4, 6 . . . 18}, a single TFC “q” would be selected from the third set {C} and disabled at 615. If, for example, TFC “2” were selected at 615, then at 620, the multimodal device 300 would transmit on the set of TFCs {3, 4, 6 . . . 18}. This example is depicted in FIG. 7(d).

At 625, the multimodal device 300 receives a signal on a single RFC, herein referred to as RFC “h”. It will be understood that from the perspective of time, transmission 620 and reception 625 may overlap, and that transmission 620 may be sustained for the duration of multiple iterations of reception 625 (as described below).

At 630, the power level of the signal received on RFC “h” (at 625) is measured to generate a power level measurement “P”. The power level measurement 630 depicted in FIG. 6 may be analogous to the power level measurement 430 depicted in FIG. 4.

At 635, the method 600 calculates an excess received power “D” by calculating the difference between the power level measurement “P” measured at 630 and a threshold value “T”. The difference is recorded in function “D(h)”, which describes the excess received power “D” associated with the signal received at any given RFC “h”.

The threshold value “T” may be selected arbitrarily. It reflects a target level of self-interference selected in accordance with the noise tolerance of the user of the multimodal device 300. If the multimodal device 300 is intended to tolerate high levels of self-interference, then the threshold value “T” can be made high, and the excess received power “D” will be reduced accordingly. Alternatively, the threshold value “T” can be made low if the multimodal device 300 is designed to be intolerant of self-interference.

At 640, the method 600 determines whether the “h” loop is complete. The “h” loop is complete when each RFC associated with a given transceiver has served as the RFC “h”. For example, if a given transceiver has M RFCs, then the “h” loop is complete after M iterations of signal reception 625, power level measurement 630, and excess received power calculation 635. As the “h” loop iterates, the function “D(h)” emerges, in which the excess received power “D” is recorded for each RFC “h”. Once the “h” loop is complete, the function “D(h)” has been defined, and the method 600 proceeds to 650. Otherwise, the method 600 proceeds to 645. It will be understood that if the multimodal device is capable of measuring the power level “P” for each RFC simultaneously, then the “h” loop may be omitted, and the function “D(h)” may be defined using the single simultaneous measurement of each RFC.

At 645, the method 600 iterates the RFC “h”. The term “iterate” encompasses any method of selecting a new RFC “h” that has not already been selected for the purpose of completing the “h” loop referred to at 640. According to the previous example (in which the transceiver has M RFCs), the value of “h” begins at 1 and increments after each iteration of the “h” loop such that “h” is set to “h+1”. In this example, the “h” loop is determined to be complete (at 640) when “h” reaches M. Generally, it will be understood that there are a number of suitable ways to ensure that signal reception 625, power level measurement 630, and excess received power calculation 635 are performed for each RFC before method 600 proceeds to 650.

At 650, the method 600 determines the highest excess received power “Dmax” from the set of measurements recorded in function “D(h)”. The method 600 uses the “Dmax” calculation to build function “U(q)”. In function “U(q)”, “U” is the highest excess received power received at any RFC while the TFC “q” is disabled.

To return to the earlier example, suppose that TFC “2” is disabled (at 615), and that the “h” loop has been completed (at 640) for each of the M RFCs. Suppose further that, during the transmissions initiated at 620, the highest excess received power level “D” at any of the M RFCs is equal to 1 μW, such that “Dmax”=1 μW. At 650, the method 600 would set “U(2)” equal to 1 μW. As the “q” loop iterates, additional values of “U” will be recorded for each value of “q”, and the function “U(q)” will emerge.

At 655, the method 600 determines whether the “q” loop is complete. The “q” loop is complete when each TFC in the third set {C} has served as the TFC “q”. For example, if the third set {C} has 16 elements such that C={2, 3, 4, 6 . . . 18}, then the “q” loop may be complete after 16 iterations of disabling 615, TFC transmission 620, and highest excess received power recording 650. Three such iterations according to this example are depicted in FIG. 7(e), FIG. 7(f), and FIG. 7(g). Once the “q” loop is complete, the method 600 proceeds to 670. Otherwise, the method 600 proceeds to 660.

At 660, the method 600 enables the TFC “q” which was disabled at 615.

At 665, the method 600 iterates the TFC “q”. As noted above, the term “iterate” encompasses any method of selecting a new TFC “q” that has not already been selected for the purpose of completing the “q” loop referred to at 655. For example, if C={2, 3, 4, 6 . . . 18} and TFCs “2” and “3” have already served as the TFC “q”, then any of the TFCs in the set {4, 6 . . . 18} may be selected at 665 to serve as the new TFC “q”. Once again, an example has been provided in which the loop begins with the lowest-numbered element and increments (q→q+1) until each element has been selected. However, it will be understood that a new TFC “q” may be selected in accordance with any appropriate mechanism, and that the disclosure is not limited to any specific order.

At 670, the method 600 determines the lowest value of “U” in the function “U(q)”, hereinafter referred to as “Umin”

At 675, the TFC associated with “Umin” is blacklisted. A blacklist that identifies blacklisted TFCs may be stored in, for example, a memory (not shown) of multimodal device 300. To return to an earlier example, suppose that TFC “2” is disabled (at 615), and that the “h” loop has been completed (at 640) for each of M RFCs. Suppose further that the highest excess received power level “D” at any of the M RFCs is equal to 1 μW, such that “Dmax”=1 μW. At 650, the method 600 would set “U(2)” equal to 1 μW. Suppose further that after 15 additional iterations of the “q” loop (in which every other TFC in C={2, 3, 4, 6 . . . 18} has served as the TFC “q”), U(2)=1 μW is still the lowest value contained in the U(q). In this scenario, the TFC associated with “Umin”, i.e., TFC “2”, would be blacklisted. This example is depicted in FIG. 7(h). In plain language, the method 600 determines that power level measurements at the RFCs are lowest when TFC “2” disabled. As a result, TFC “2” is blacklisted.

At 680, the method 600 determines whether “Umin” is less than zero. If “Umin” is less than zero, then the method 600 terminates. Otherwise, the method 600 proceeds to 610, where the process is repeated with one additional TFC on the blacklist. In plain language, the method 600 continues until sufficient TFCs are selectively blacklisted so as to ensure that no RFC associated with the multimodal device 300 (or no particular subset of such RFCs) receives a signal having a power level “P” above the threshold “T”. As noted above, every time a new TFC is added to the blacklist, the number of elements in the third set {C} is reduced by one. To return to the previous example, suppose that C={2, 3, 4, 6 . . . 18} (wherein “1” and “5” cannot be added to the blacklist and are therefore excluded from the third set {C}, and “19” and “20” are already on the blacklist and are therefore excluded from the third set {C}). Suppose further that TFC “2” is subsequently blacklisted at 675. In this scenario, the third set {C} would be updated such that C={3, 4, 6 . . . 18}. Subsequently, every TFC in the third set {C} would be enabled at 610, a single TFC “q” would be selected from the third set {C} at 615, and the method 600 would continue through another iteration. The iterations would continue until “Umin” is determined to be less than zero (at 680).

FIG. 7(a) through FIG. 7(h) each illustrate a diagram relating to a set of TFCs at different points in time during an exemplary performance of the method 600 described above.

FIG. 7(a) generally illustrates a set of twenty TFCs, denominated “1” through “20”. As noted above, each TFC associated with the multimodal device 300 can be categorized as part of either a first set {A} of TFCs or a second set {B} of TFCs. The TFCs may be associated with a one transceiver, for example, third transceiver 310c of FIG. 3, or more than one transceiver, for example, first transceiver 310a and third transceiver 310c of FIG. 3. For example, the TFCs referred to in method 600 of FIG. 6 may comprise every TFC associated with the multimodal device 300 of FIG. 3, including first transceiver 310a, second transceiver 310b, and third transceiver 310c, or any subset thereof.

The RFCs may be associated with one transceiver, more than one transceiver, or any subset or subsets of the one or more transceivers. The RFCs may be associated with a different transceiver than that which the TFCs are associated. Additionally or alternatively, the RFCs may be associated with the same transceiver than that which the TFCs are associated.

For the purposes of FIG. 7(a), it is not necessary to identify which transceiver or transceivers are associated with each of TFCs “1” through “20”. It is sufficient to state that TFCs “1” through “20” are distinct TFCs associated with the multimodal device 300.

FIG. 7(b) generally illustrates the set of twenty TFCs from FIG. 7(a) at a subsequent point in time during an exemplary performance of method 600. In particular, the twenty TFCs have been divided into a first set {A} and a second set {B}. As noted in the description of FIG. 6, each TFC associated with the multimodal device 300 can be categorized as part of either a first set {A} (TFCs that cannot be blacklisted) or a second set {B} (TFCs that can be blacklisted). The TFCs that cannot be blacklisted may be identified by the blacklist mask 380, as noted above. In this example, TFCs “1” and “5” cannot be blacklisted.

FIG. 7(c) generally illustrates the set of twenty TFCs from FIG. 7(b) at a subsequent point in time during an exemplary performance of method 600. In particular, the TFCs “19” and “20” have been blacklisted during two complete iterations of the method 600. As noted above with respect to FIG. 6, “Umin” is determined at 670, and the TFC that is associated with “Umin” can be blacklisted at 675. In the scenario of FIG. 7(c), both of TFC “19” and TFC “20” have been blacklisted in accordance with the method 600 depicted in FIG. 6.

FIG. 7(d) generally illustrates the set of twenty TFCs from FIG. 7(c) at a subsequent point in time during an exemplary performance of method 600. In the scenario of FIG. 7(d) the method 600 has not only blacklisted TFCs “19” and “20” (at 675), but subsequently determined that “Umin” is not less than zero (at 680). As a result, the method 600 has returned to 610 for a third iteration of method 600. At 610, the blacklisted TFCs are disabled. According to this example, the blacklisted TFCs “19” and “20” have been excluded from the third set {C}. Moreover, at 615, a TFC “q” has been selected for disabling from the third set {C}. In particular, TFC “2” has been selected for disabling.

FIG. 7(e) generally illustrates the set of twenty TFCs from FIG. 7(d) at a subsequent point in time during an exemplary performance of method 600. In the scenario of FIG. 7(e), the multimodal device 300 transmits on each enabled TFC (at 620). As noted above, the multimodal device 300 transmits on each TFC in the first set {A}. The multimodal device 300 also transmits on each TFC in the third set {C}, except for the single TFC “q”. According to this example, TFC “2” is selected as TFC “q” and therefore disabled (at 615), and TFCs “19” and “20” are blacklisted and therefore not included in the third set {C}. As a result, the multimodal device transmit on every TFC except TFCs “2”, “19”, and “20”.

FIG. 7(f) generally illustrates the set of twenty TFCs from FIG. 7(e) at a subsequent point in time during an exemplary performance of method 600. In the scenario of FIG. 7(f), the “h” loop has been completed for each RFC (at 640), and the value “U(2)” has been recorded in the function “U(q)” (at 650). Moreover, the method 600 has looped back to 615. In the course of looping back to 615, the method 600 has enabled the TFC “q” at 660 (TFC “2” according to this example). Moreover, the method 600 has iterated “q” at 665 such that a new TFC “q” is selected from disabling from the third set {C} (TFC “3” according to this example). Then, at 620, the multimodal device transmits on each enabled TFC. According to this example, TFC “3” is now disabled instead of TFC “2”.

FIG. 7(g) generally illustrates the set of twenty TFCs from FIG. 7(f) at a subsequent point in time during an exemplary performance of method 600. In the scenario of FIG. 7(g), the “q” loop is in its last iteration. According to this example, each TFC in the third set {C} has been selectively disabled (at 615) exactly once, and TFC “18” is the last TFC in the third set {C} to be selectively disabled. In this example, C={2, 3, 4, 6 . . . 18}, and the method 600 has selected each element in the third set {C}, beginning with the lowest and incrementing upward to TFC “18”. It will be understood that this is merely an example, and that the elements of the third set {C} may be selectively disabled in any order.

FIG. 7(h) generally illustrates the set of twenty TFCs from FIG. 7(g) at a subsequent point in time during an exemplary performance of method 600. In the scenario of FIG. 7(h), the method 600 has recorded a value “U” (at 650) for each TFC “q” in the third set {C}. The function “U(q)” therefore emerges after the “q” loop is completed (at 655). At 670, “Umin” is determined (at 670) from among the “U” values in the function “U(q)”. In this example, “U(2)” is determined to be equal to 1 μW, and 1 μW is determined to be the smallest “U” value in the function “U(q)”. As a result, “Umin” is determined to be 1 μW at 670, and the TFC associated with “Umin”, i.e. TFC “2”, is blacklisted (at 675). FIG. 7(h) shows a scenario in which TFC “2” has been blacklisted and the third set {C} has been updated to exclude not only TFCs “19” and “20”, but also TFC “2”.

It will be understood that FIG. 7(a) through FIG. 7(h) merely show an example set of TFCs at various points of time during an exemplary performance of method 600. The first set {A} may comprise any number of TFCs (including zero), and any of the TFCs associated with a given multimodal device 300 may be included in the first set {A}. TFCs “1” and “5” are shown as examples. Moreover, any of the TFCs included in the second set {B} may be blacklisted during the performance of method 600 (or none may be blacklisted), and the TFCs that are blacklisted may be blacklisted in any order. TFCs “19”, “20”, and “2” are shown as examples.

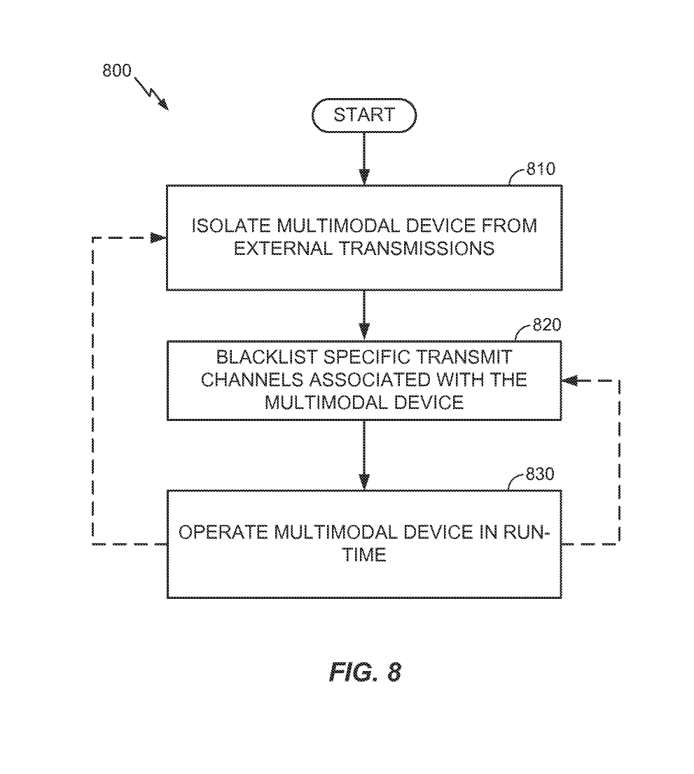

FIG. 8 generally illustrates a method 800 of operating a multimodal device such as, for example, the multimodal device 300.

At 810, the multimodal device 300 is isolated from external transmissions. For example, the multimodal device 300 may be provided to an environment in which there are no signals being transmitted on the frequencies associated with the RFCs of the device. In other words, the environment may be free of all transmissions except for background noise.

At 820, specific TFCs associated with the multimodal device 300 are blacklisted. For example, method 600 may be performed at 820 in the isolated environment provided at 810. In one possible scenario, the method 600 is most effective when performed in an isolated environment, and is therefore performed at 820 of the method 800 depicted in FIG. 8.

At 830, the multimodal device 300 is operated in run-time. The TFCs identified on the blacklist are not used during the run-time operations 830. In one possible scenario, the method 800 performs isolation 810 and blacklisting 820 as part of a self-calibration scheme prior to run-time operation of the device at 830. Moreover, the method 800 may loop back to 820 in order to perform the blacklisting 820 again. For example, if the multimodal device 300 determines that self-interference is or may be occurring, then the multimodal device 300 may cease to operate in run-time 830 and perform blacklisting 820. Additionally or alternatively, an operator of the multimodal device 300 may determine the recalibration is necessary and request that the multimodal device 300 perform blacklisting 820 again. The blacklisting 820 may consist solely of the method 600, or may comprise further calibration or recalibration methods. In yet another alternative, the method 800 may loop back to isolation 810.

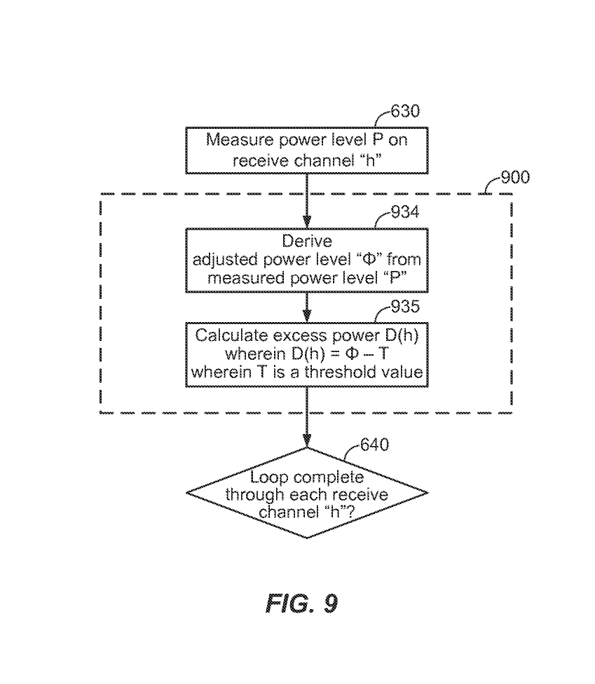

FIG. 9 generally illustrates a modification 900 to the method 600 of FIG. 6. In accordance with the modification 900, 635 of the method 600 is omitted and replaced with 934 and 935. In other words, whereas method 600 proceeds from 630 to 635 to 640, the method 600 performed in accordance with modification 900 proceeds from 630 to 934 to 935 to 640.

At 934, the power level “P” measured at 630 of method 600 is used to derive an adjusted power level “φ”. The adjusted power level “φ” may be derived at 934 by adding one or more blacklisting cost values to the measured power level “P”. The blacklisting cost values are generated using a cost function, which penalizes excessive blacklisting of channels in a transceiver. Self-interference can be minimized using the method 600 by blacklisting a large number of channels, but at some point, it is no longer desirable to blacklist additional channels in exchange for marginal reductions in self-interference. Accordingly, the method 600 can be performed in accordance with modification 900 so as to internalize the cost of excessive blacklisting by arbitrarily increasing the value for the power level “P” in accordance with the cost function.

In one scenario, a blacklisting cost value “BL” is added to the power level “P” in order to derive the adjusted power level “φ”. The cost function may be defined such that the blacklisting cost value BL is proportional to a total number of blacklisted channels. Additionally or alternatively, the blacklisting cost value BL is proportional to a percentage of blacklisted channels relative to a total number of channels. In this scenario, φ=P+BL.

In another scenario, a blacklisting cost value “BLᵢ” is added for each of i transceivers. For example, in a system with three transceivers 310a, 310b, 310c, the adjusted power level “φ” may be set equal to P+BL₁+BL₂+BL₃, where blacklisting costs BL₁, BL₂, and BL₃ represent the cost of blacklisting the blacklisted channels from the first transceiver 310a, second transceiver 310b, and third transceiver 310c, respectively. BLᵢ may be equal to, for example, 1/(1−xᵢ), where xᵢ is equal to the percentage of blacklisted channels associated with the i^{th} transceiver. It will be understood that as the percentage of blacklisted channels xᵢ increases, the blacklisting cost BLᵢ will also increase. For example, before any blacklisting occurs, BLᵢ will be equal to 1. After 5% of channels associated with the i^{th} transceiver are blacklisted, BLᵢ will increase to approximately 1.05, after 50% of channels associated with the i^{th} transceiver are blacklisted, BLᵢ will increase to 2, after 90% of channels associated with the i^{th} transceiver are blacklisted, BLᵢ will increase to 10, etc. It will be appreciated that the penalty will continue to increase as a greater percentage of channels xᵢ are blacklisted.

In another example, BLᵢ is equal to (xᵢ)ⁿ, where xᵢ is equal to the total number of blacklisted channels associated with the i^{th} transceiver, and n is an arbitrary constant. If n=2, for example, then before any blacklisting occurs, BLᵢ will be equal to 0. After 1 channel associated with the i^{th} transceiver is blacklisted, BLᵢ will increase to 1, after 2 channels associated with the i^{th} transceiver are blacklisted, BLᵢ will increase to 4, after 3 channels associated with the i^{th} transceiver are blacklisted, BLᵢ will increase to 9, etc. It will be appreciated that the penalty will continue to increase as a greater number of channels xᵢ are blacklisted. It will be understood that n may be increased or decreased to make the cost function more or less punitive. Moreover, it will be understood that n may be independently selected for each transceiver such that n=nᵢ. For example, n₁ may be set to 1.5 and n₂ may be set to 3.

At 935, the modification 900 calculates an excess received power “D” by calculating the difference between the adjusted power level “φ” measured at 934 and a threshold value “T”. The difference is recorded in function “D(h)”, which describes the excess received power “D” associated with the signal received at any given RFC “h”. It will be understood that 935 is analogous to 635, except that where 635 uses the non-adjusted power level “P” (measured at 630) to calculate excess received power “D”, 935 uses the adjusted power level “φ” derived at 934. After calculating the excess received power “D” at 935, the modified portion of the method 600 (i.e., the modification 900) is complete, and the flow returns to 640, where in accordance with the method 600, it is determined whether the “h” loop is complete.

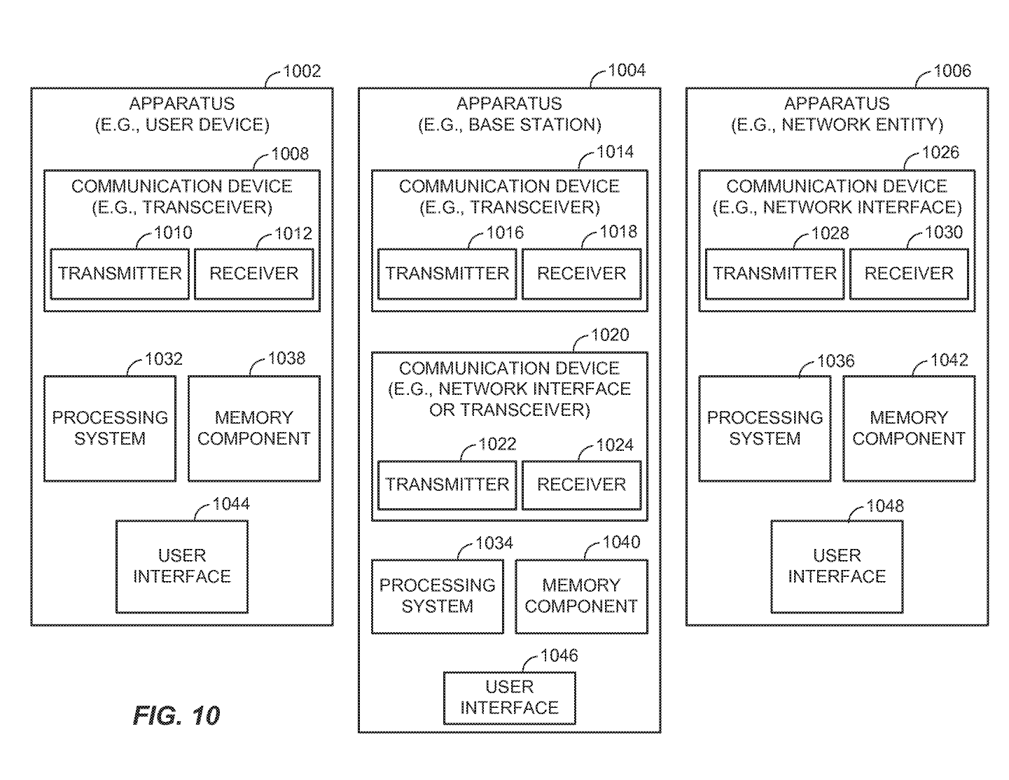

FIG. 10 illustrates several sample components (represented by corresponding blocks) that may be incorporated into an apparatus 1002, an apparatus 1004, and an apparatus 1006 (corresponding to, for example, a user device, a base station, and a network entity, respectively) to support the blacklisting operations, etc., as taught herein. It will be appreciated that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 1002 and the apparatus 1004 each include at least one wireless communication device (represented by the communication devices 1008 and 1014 (and the communication device 1020 if the apparatus 1004 is a relay)) for communicating with other nodes via at least one designated RAT. Each communication device 1008 includes at least one transmitter (represented by the transmitter 1010) for transmitting and encoding signals (e.g., messages, indications, information, and so on) and at least one receiver (represented by the receiver 1012) for receiving and decoding signals (e.g., messages, indications, information, pilots, and so on). Similarly, each communication device 1014 includes at least one transmitter (represented by the transmitter 1016) for transmitting signals (e.g., messages, indications, information, pilots, and so on) and at least one receiver (represented by the receiver 1018) for receiving signals (e.g., messages, indications, information, and so on). If the apparatus 1004 is a relay station, each communication device 1020 may include at least one transmitter (represented by the transmitter 1022) for transmitting signals (e.g., messages, indications, information, pilots, and so on) and at least one receiver (represented by the receiver 1024) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. A wireless communication device (e.g., one of multiple wireless communication devices) of the apparatus 1004 may also comprise a Network Listen Module (NLM) or the like for performing various measurements.

The apparatus 1006 (and the apparatus 1004 if it is not a relay station) includes at least one communication device (represented by the communication device 1026 and, optionally, 1020) for communicating with other nodes. For example, the communication device 1026 may comprise a network interface that is configured to communicate with one or more network entities via a wire-based or wireless backhaul. In some aspects, the communication device 1026 may be implemented as a transceiver configured to support wire-based or wireless signal communication. This communication may involve, for example, sending and receiving: messages, parameters, or other types of information. Accordingly, in the example of FIG. 10, the communication device 1026 is shown as comprising a transmitter 1028 and a receiver 1030. Similarly, if the apparatus 1004 is not a relay station, the communication device 1020 may comprise a network interface that is configured to communicate with one or more network entities via a wire-based or wireless backhaul. As with the communication device 1026, the communication device 1020 is shown as comprising a transmitter 1022 and a receiver 1024.

The apparatuses 1002, 1004, and 1006 also include other components that may be used in conjunction with the blacklisting operations, etc., as taught herein. The apparatus 1002 includes a processing system 1032 for providing functionality relating to, for example, implementing the channel blacklisting algorithm component 370 as taught herein and for providing other processing functionality. The apparatus 1004 includes a processing system 1034 for providing functionality relating to, for example, implementing the channel blacklisting algorithm component 370 as taught herein and for providing other processing functionality. The apparatuses 1002, 1004, and 1006 include memory components 1038, 1040, and 1042 (e.g., each including a memory device), respectively, for maintaining information (e.g., information indicative of reserved resources, thresholds, parameters, and so on). In addition, the apparatuses 1002, 1004, and 1006 include user interface devices 1044, 1046, and 1048, respectively, for providing indications (e.g., audible and/or visual indications) to a user and/or for receiving user input (e.g., upon user actuation of a sensing device such a keypad, a touch screen, a microphone, and so on).

For convenience, the apparatuses 1002, 1004, and/or 1006 are shown in FIG. 10 as including various components that may be configured according to the various examples described herein. It will be appreciated, however, that the illustrated blocks may have different functionality in different designs.

The components of FIG. 10 may be implemented in various ways. In some implementations, the components of FIG. 10 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1008, 1032, 1038, and 1044 may be implemented by processor and memory component(s) of the apparatus 1002 (e.g., by execution of appropriate code and/or by appropriate configuration of processor components). Similarly, some or all of the functionality represented by blocks 1014, 1020, 1034, 1040, and 1046 may be implemented by processor and memory component(s) of the apparatus 1004 (e.g., by execution of appropriate code and/or by appropriate configuration of processor components). Also, some or all of the functionality represented by blocks 1026, 1036, 1042, and 1048 may be implemented by processor and memory component(s) of the apparatus 1006 (e.g., by execution of appropriate code and/or by appropriate configuration of processor components).

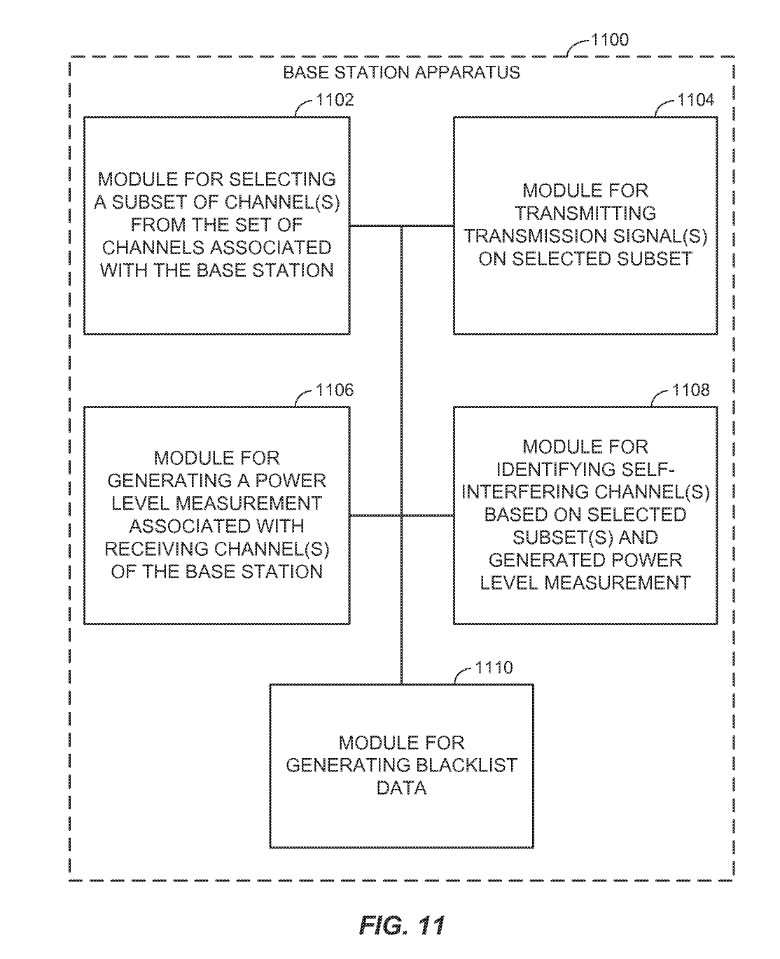

FIG. 11 illustrates an example base station apparatus 1100 represented as a series of interrelated functional modules. A module for selecting a subset of one or more channel from the set of channels associated with the base station 1102 may correspond at least in some aspects to, for example, an RF coexistence manager 102, Wi-Fi radio 202, LTE radio 204, processor 222, memory 224, first transceiver 310a, second transceiver 310b, third transceiver 310c, transmitter 1016, transmitter 1022, processing system 1034, memory component 1040, etc., as discussed herein. A module for transmitting one or more transmission signals on the selected subset 1104 may correspond at least in some aspects to, for example, an RF coexistence manager 102, Wi-Fi radio 202, LTE radio 204, first transceiver 310a, second transceiver 310b, third transceiver 310c, transmitter 1016, transmitter 1022, processing system 1034, memory component 1040, etc., as discussed herein. A module for generating a power level measurement associated with one or more receiving channels associated with the base station 1106 may correspond at least in some aspects to, for example, an RF coexistence manager 102, Wi-Fi radio 202, LTE radio 204, NL module 206, NL module 208, received power measurement component 360, receiver 1018, receiver 1024, processing system 1034, memory component 1040, etc., as discussed herein. A module for identifying one or more self-interfering channels based on one or more selected subset(s) and generate power level measurements 1108 may correspond at least in some aspects to, for example, RF coexistence manager 102, processor 222, memory 224, first transceiver 310a, second transceiver 310b, third transceiver 310c, processing system 1034, memory component 1040, etc., as discussed herein. A module for generating blacklist data 1110 may correspond at least in some aspects to, for example, RF coexistence manager 102, processor 222, memory 224, first transceiver 310a, second transceiver 310b, third transceiver 310c, processing system 1034, memory component 1040, etc., as discussed herein.

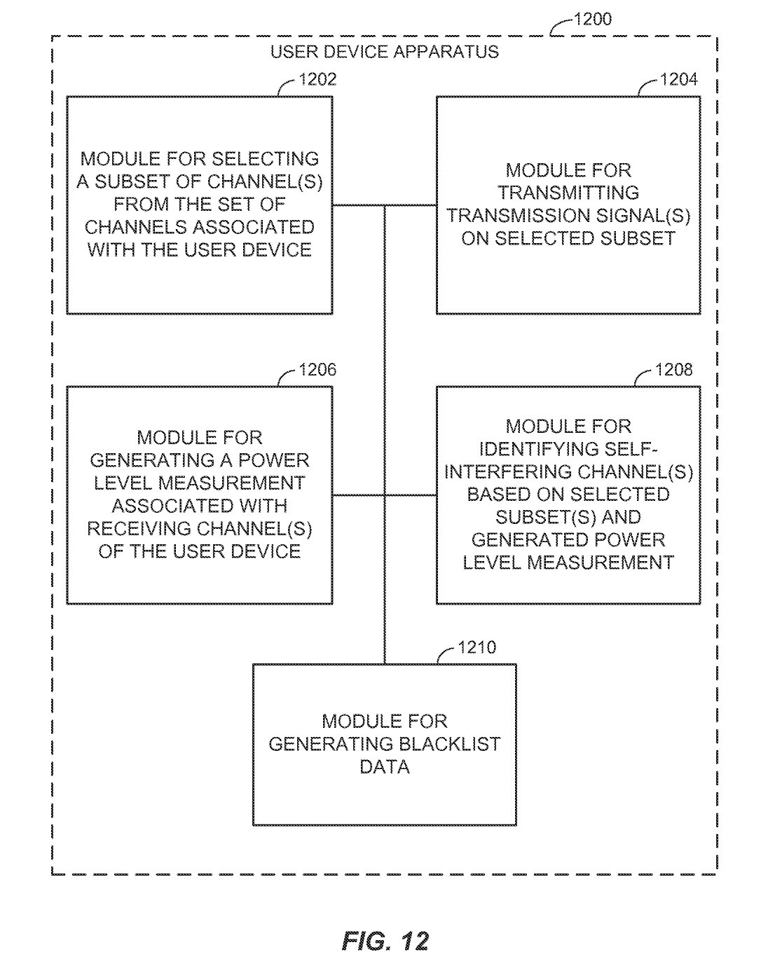

FIG. 12 illustrates an example user device apparatus 1200 represented as a series of interrelated functional modules. A module for selecting a subset of one or more channel from the set of channels associated with the base station 1202 may correspond at least in some aspects to, for example, an RF coexistence manager 112, first transceiver 310a, second transceiver 310b, third transceiver 310c, transmitter 1010, processing system 1032, memory component 1038, etc., as discussed herein. A module for transmitting one or more transmission signals on the selected subset 1204 may correspond at least in some aspects to, for example, an RF coexistence manager 112, first transceiver 310a, second transceiver 310b, third transceiver 310c, transmitter 1010, processing system 1032, memory component 1038, etc., as discussed herein. A module for generating a power level measurement associated with one or more receiving channels associated with the base station 1206 may correspond at least in some aspects to, for example, an RF coexistence manager 112, NL module 206, NL module 208, received power measurement component 360, receiver 1012, processing system 1032, memory component 1038, etc., as discussed herein. A module for identifying one or more self-interfering channels based on one or more selected subset(s) and generate power level measurements 1208 may correspond at least in some aspects to, for example, RF coexistence manager 112, first transceiver 310a, second transceiver 310b, third transceiver 310c, processing system 1032, memory component 1038, etc., as discussed herein. A module for generating blacklist data 1210 may correspond at least in some aspects to, for example, RF coexistence manager 112, first transceiver 310a, second transceiver 310b, third transceiver 310c, processing system 1032, memory component 1038, etc., as discussed herein.

The functionality of the modules of FIGS. 11-13 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 11-13, as well as other components and functions described herein, may be implemented using any suitable means. Such means also may be implemented, at least in part, using corresponding structure as taught herein. For example, the components described above in conjunction with the “module for” components of FIGS. 11-13 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory, computer-readable storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for improving RF coexistence in a multimodal device.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

1. A method of improving radio frequency coexistence in a multimodal device comprising:
selecting, at the multimodal device, a subset comprising at least one transmitter frequency channel (TFC) from among a set of TFCs associated with the multimodal device;
transmitting, from the multimodal device, a transmission signal on each TFC of the selected subset;
generating a power level measurement based on a signal received at the multimodal device during transmitting of the transmission signal at a receiving frequency channel (RFC) associated with the multimodal device; and
identifying a self-interfering TFC from among the set of TFCs based on the selected subset and the generated power level measurement.

2. The method of claim 1, further comprising:
generating blacklist data associated with the identity of the self-interfering TFC;
generating a set of available TFCs by eliminating the self-interfering TFC identified in the blacklist data from the set of TFCs associated with the multimodal device; and
transmitting an indication of the available TFCs.

3. The method of claim 1, wherein selecting the subset comprises:
identifying each TFC in the set of TFCs associated with the multimodal device; and
enabling for transmission each TFC in the set of TFCs.

4. The method of claim 3, wherein selecting the subset further comprises:
identifying at least one blacklisted TFC based on a table of blacklist data;
disabling each blacklisted TFC; and
disabling one additional TFC that is not a blacklisted TFC.

5. The method of claim 4, wherein selecting the subset further comprises:
dividing the set of TFCs into a first set of TFCs that cannot be blacklisted and a second set of TFCs that can be blacklisted; and
identifying a third set of TFCs comprising every TFC from the second set of TFCs that is not identified as a blacklisted TFC;
wherein the disabled additional TFC is selected from the third set of TFCs.

6. The method of claim 5, wherein identifying the self-interfering TFC comprises:
calculating an excess received power based on a difference between the generated power level measurement value and a target value; and
recording a calculated excess received power value such that the calculated excess received power value is indexed to the disabled additional TFC.

7. The method of claim 5, wherein selecting the subset further comprises:
(i) enabling the disabled additional TFC;
(ii) disabling a new disabled additional TFC that is selected from the third set of TFCs; and
iteratively (i) enabling the disabled additional TFC and (ii) disabling the new disabled additional TFC until each TFC in the third set of TFCs has been disabled exactly once.

8. The method of claim 7, wherein identifying the self-interfering TFC comprises iteratively calculating, during iterative periods in which the new disabled additional TFC is disabled, a new excess received power value based on a difference between a new generated power level measurement and a target value.

9. The method of claim 8, wherein identifying the self-interfering TFC further comprises:
determining a lowest single value of the iteratively calculated excess received power values;
determining which TFC of the third set of TFCs is associated with the lowest single value of the iteratively calculated excess received power values; and
identifying the TFC associated with the lowest single value of the iteratively calculated excess received power values.

10. The method of claim 9, wherein identifying the self-interfering TFC further comprises:
determining whether the lowest single value of the iteratively calculated excess received power values is less than zero; and
selecting a new subset in response to a determination that the lowest single value of the iteratively calculated excess received power values is not less than zero.

11. The method of claim 1, wherein transmitting the transmission signal comprises simultaneously transmitting a transmission signal at maximum transmission power on each TFC of the selected subset.

12. The method of claim 1, wherein generating the power level measurement comprises iteratively generating a power level measurement for each of a plurality of RFCs associated with the multimodal device.

13. The method of claim 1, wherein generating the power level measurement based on the signal received at the receiving frequency channel (RFC) associated with the multimodal device occurs simultaneously with transmitting the transmission signal on each TFC of the selected subset.

14. The method of claim 1, wherein:
selecting a subset further comprises selecting a subset including TFCs within a frequency band associated with (i) second generation (2G), (ii) third generation (3G), (iii) fourth generation (4G), (iv) Long Term Evolution (LTE), (v) Wi-Fi, (vi) Bluetooth, or (vii) any combination of (i), (ii), (iii), (iv), (v), and (vi); and
generating the power level measurement further comprises generating a power level measurement based on an RFC within a frequency band associated with (i) second generation (2G), (ii) third generation (3G), (iii) fourth generation (4G), (iv) Long Term Evolution (LTE), (v) Wi-Fi, (vi) Bluetooth, or (vii) any combination of (i), (ii), (iii), (iv), (v), and (vi).

15. An apparatus for improving radio frequency coexistence in a multimodal device, comprising:
means for selecting, at the multimodal device, a subset comprising at least one transmitter frequency channel (TFC) from among a set of TFCs associated with the multimodal device;
means for transmitting, from the multimodal device, a transmission signal on each TFC selected by the means for selecting a subset;
means for generating a power level measurement based on a signal received at the multimodal device during transmitting of the transmission signal at a receiving frequency channel (RFC) associated with the multimodal device; and
means for identifying a self-interfering TFC from among the set of TFCs based on the subset selected by the means for selecting a subset and the power level measurement generated by the means for generating a power level measurement.

16. The multimodal device of claim 15, further comprising:
means for generating blacklist data associated with the identity of the self-interfering TFC;
means for generating a set of available TFCs by eliminating the self-interfering TFC identified in the blacklist data from the set of TFCs associated with the multimodal device; and
means for transmitting an indication of the available TFCs.

17. The multimodal device of claim 15, wherein means for selecting a subset comprises:
means for identifying each TFC in the set of TFCs associated with the multimodal device; and
means for enabling for transmission each TFC in the set of TFCs.

18. A non-transitory computer-readable medium storing code, which, when executed by a processor, causes the processor to perform operations for improving radio frequency coexistence in a multimodal device, the non-transitory computer-readable medium comprising:
code for selecting, at the multimodal device, a subset comprising at least one transmitter frequency channel (TFC) from among a set of TFCs associated with the multimodal device;
code for transmitting, from the multimodal device, a transmission signal on each TFC of the selected subset;
code for generating a power level measurement based on a signal received at the multimodal device during transmitting of the transmission signal at a receiving frequency channel (RFC) associated with the multimodal device; and
code for identifying a self-interfering TFC from among the set of TFCs based on the selected subset and the generated power level measurement.

19. The non-transitory computer-readable medium of claim 18, further comprising:
code for generating blacklist data associated with the identity of the self-interfering TFC;
code for generating a set of available TFCs by eliminating the self-interfering TFC identified in the blacklist data from the set of TFCs associated with the multimodal device; and
code for transmitting an indication of the available TFCs.

20. The non-transitory computer-readable medium of claim 18, wherein the code for selecting the subset comprises:
code for identifying each TFC in the set of TFCs associated with the multimodal device; and
code for enabling for transmission each TFC in the set of TFCs.

21. A multimodal device comprising:
a channel blacklisting algorithm component configured to select, at the multimodal device, a subset comprising at least one transmitter frequency channel (TFC) from among a set of TFCs associated with the multimodal device;
at least one transceiver configured to transmit, from the multimodal device, a transmission signal on each TFC of the selected subset; and
a received power measurement component configured to generate a power level measurement based on a signal received at the multimodal device at a receiving frequency channel (RFC) associated with the multimodal device;
wherein the channel blacklisting algorithm component is further configured to identify a self-interfering TFC from among the set of TFCs based on the selected subset and the power level measurement generated by the received power measurement component.

22. The multimodal device of claim 21, wherein:
the channel blacklisting algorithm component is further configured to generate blacklist data associated with the identity of the self-interfering TFC and generate a set of available TFCs by eliminating the self-interfering TFC identified in the blacklist data from the set of TFCs associated with the multimodal device; and
the at least one transceiver is further configured to transmit an indication of the available TFCs.

23. The multimodal device of claim 21, wherein the channel blacklisting algorithm component is further configured to:
identify each TFC in the set of TFCs associated with the multimodal device; and
enable for transmission each TFC in the set of TFCs.

24. The multimodal device of claim 23, wherein the channel blacklisting algorithm component is further configured to:
identify at least one blacklisted TFC based on a table of blacklist data;
disable each blacklisted TFC; and
disable one additional TFC that is not a blacklisted TFC.

25. The multimodal device of claim 24, wherein the channel blacklisting algorithm component is further configured to:
divide the set of TFCs into a first set of TFCs which cannot be blacklisted and a second set of TFCs that can be blacklisted; and
identify a third set of TFCs comprising every TFC from the second set of TFCs that is not identified as a blacklisted TFC;
wherein the disabled additional TFC is selected from the third set of TFCs.

26. The multimodal device of claim 25, wherein the channel blacklisting algorithm component is further configured to:
calculate an excess received power based on a difference between the generated power level measurement and a target value; and
record the calculated excess received power such that the excess received power is indexed to the disabled additional TFC.

27. The multimodal device of claim 25, wherein the channel blacklisting algorithm component is further configured to:
(i) enable the disabled additional TFC;
(ii) disable a new disabled additional TFC that is selected from the third set of TFCs; and
iteratively (i) enable the disabled additional TFC and (ii) disable the new disabled additional TFC until each TFC in the third set of TFCs has been disabled exactly once.

28. The multimodal device of claim 27, wherein the channel blacklisting algorithm component is further configured to iteratively calculate, during iterative periods in which the new disabled additional TFC is disabled, an excess received power value based on a difference between the generated power level measurement and a target value.

29. The multimodal device of claim 28, wherein the channel blacklisting algorithm component is further configured to:
determine a lowest single value of the iteratively calculated excess received power values;
determine which TFC of the third set of TFCs is associated with the lowest single value of the iteratively calculated excess received power values; and
identify the TFC associated with the lowest single value of the iteratively calculated excess received power values.

30. The multimodal device of claim 29, wherein the channel blacklisting algorithm component is further configured to:
determine whether the lowest single value of the iteratively calculated excess received power values is less than zero; and
select a new subset in response to a determination that the lowest single value of the iteratively calculated excess received power values is not less than zero.
